(19) United States
(12) Patent Application Publication
(10) Pub. No.: US 2020/0165861 A1
(43) Pub. Date: May 28, 2020

(54) SMART CONTAINER AND METHOD OF USE

(71) Applicant: Dolkens Bruno, Boynton Beach, FL (US)

(72) Inventor: Dolkens Bruno, Boynton Beach, FL (US)

(21) Appl. No.: 16/696,535

(22) Filed: Nov. 26, 2019

Related U.S. Application Data
(60) Provisional application No. 62/771,200, filed on Nov. 26, 2018.

(51) Int. Cl. E05G 1/04; B65D 25/14; B65D 81/38; E05B 65/52; G07C 9/00

(52) U.S. Cl. CPC E05G 1/04; B65D 25/14; G07C 9/00182; E05B 65/52; B65D 81/38

(57) ABSTRACT

A smart container, system, and method which prevents delivery personnel from accessing the contents stored in a delivery bag until delivery to an end user.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/771,200, entitled “SMART CONTAINER AND METHOD OF USE”, filed Nov. 26, 2018. The contents of the above referenced application are incorporated herein by reference.

### FIELD OF THE INVENTION

The present invention is related to a system, device and method for maintaining items secured in lockable delivery or a storage unit; and more particularly, to systems and methods to prevent delivery personnel from accessing the contents stored in a delivery bag until delivery to an end user.

### BACKGROUND OF THE INVENTION

Food delivery services are exploding onto the food scene. Delivery of restaurant meals to the home is rapidly changing as online platforms extend markets and make it easier for the consumer. Previously, most food deliveries were the result of the consumer ordering from a local Chinese or pizza restaurant. Once the food was ordered, the restaurant would have one of its own employees deliver the food to the consumer. With new online platforms, more restaurants are participating in home delivery than ever before. While many restaurants have their own delivery system, more and more restaurants use a third-party entity for delivering their food. While this may be more cost effective for the restaurant owner and allow for greater food delivery options, controlling who actually delivers the food can be an issue. When restaurants use their own delivery system, they can more easily monitor who is delivering their food. With a third party delivering to the consumer, this becomes much more difficult, as they have no control over who shows up to pick up the food and deliver it to the consumer. The consumer is at risk for delivery related issues, such as intentional food contamination caused by the delivery agent, as well. Particularly in big cities or densely populated areas, a person ordering from their local Chinese restaurants may not see the same delivery person on a routine basis. Even if the delivery agent has no personal issues with the consumer, they may have issues with the delivery company or the restaurant that prepared the food, and may wish to act out against either. Such disgruntled worker may secretly contaminate or poison the food, or even eat portions of the food once the delivery agent picks up the food and prior to actual delivery. The delivery company, the restaurant, nor the end user may ever know this occurred.

### SUMMARY OF THE INVENTION

A smart container, system, and method which prevents delivery personnel from accessing the contents stored in a delivery bag until delivery to an end user consumer.

Accordingly, it is an objective of the invention to provide a device, system, and method of preventing access to contents within a storage container until delivery to the end user, in which the end user has a unique access code to open the locked container.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative embodiment of a smart container, shown in the open position;

FIG. 2 is an alternative perspective view of the smart container, shown in the open position;

FIG. 3 is a perspective view of the smart container, shown in the closed and locked position;

FIG. 4 is a back view of the smart container;

FIG. 5 is a front view of the smart container;

FIG. 6 is an illustrative example of a lock box control unit;

FIG. 7 is an illustrative example of a locking assembly;

FIG. 8 is a schematic representation of the working components of the lock box control unit; and

FIG. 9 is an illustrative example of an electronic device with an electronic password.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

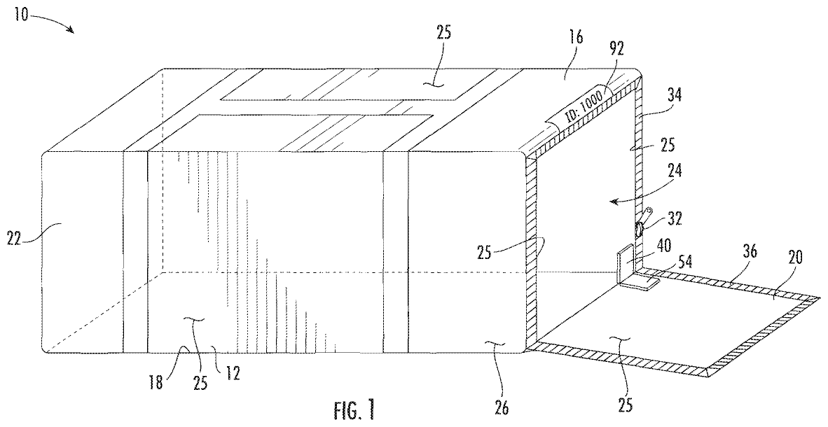

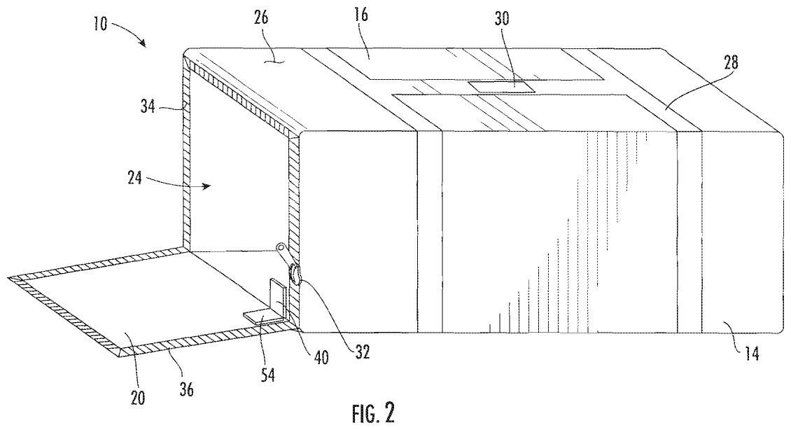

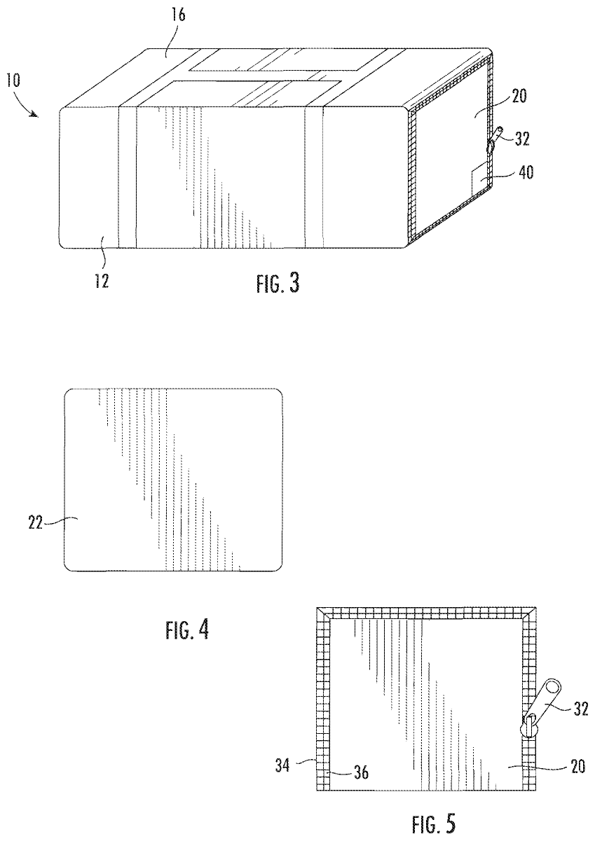

Referring to FIGS. 1-5, an electronically lockable container, referred to generally as a smart container 10, is illustrated. While the smart container 10 is illustrated for the use of safely and securely delivering food items, the smart container 10 may be used and configured for other purposes, such as a suitcase or delivery of other types of goods. The smart container 10 comprises two opposing side walls 12 and 14, a top wall 16, a bottom wall 18, a front wall 20, and a back wall 22. The two opposing side walls 12 and 14, top wall 16, bottom wall 18, front wall 20, and back wall 22 are arranged to enclose an interior portion 24. The interior portion 24 is sized and shaped to hold various objects, including food stored within delivery container, such as pizza in a pizza box, Chinese food in a Chinese take-out container, or chicken and pasta in a plastic, Styrofoam, or aluminum container.

The smart container 10 may be made of a soft, flexible or semi-flexible material such as nylon, heavy duty vinyl, or a breathable GOTEK 900D fabric with a polyurethane (PU) coating to withstand abrasions, or a hard or inflexible material such as a plastic material. The interior region 24 may include an interior surface 25, such as a leak resistant lining/material to prevent liquids from damaging the smart container 10, a closed cell foam padding for providing insulation and body to the smart container 10, a heat or cold reflective insulated interior with energy shield lining/material for keeping food hot, cold or frozen for a predetermined period of time, or combinations thereof. The external surface 26 of the smart container 10 may include nylon webbing 28 with VELCRO (hook and loop fasteners) handles 30. The nylon webbing 28 may extend around the smart container 10 for added support.

The front wall 20 may be secured to various portions of the smart container 10 via a securing mechanism so that the contents stored within the interior region 24 are sealed therein. As shown in FIGS. 1-3, the securing mechanism 32, illustrated as a zipper slider. The zipper slider 32 runs along two rows of protruding teeth, first row 34 and second row 36, which may be interdigitated, linking the rows. Other securing mechanisms known to one of skill in the art may be used as well.

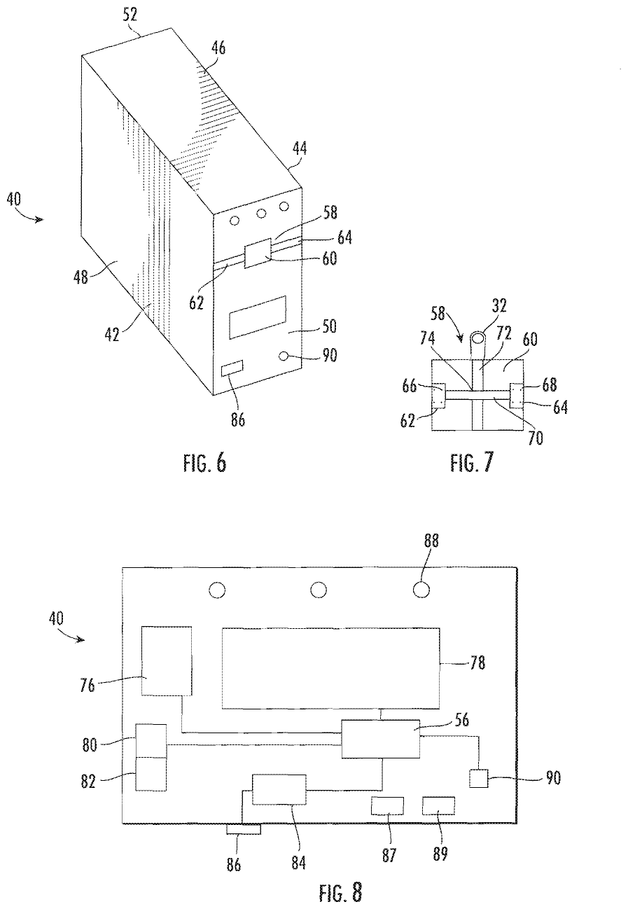

Secured to the side wall 14 is a lock box control unit 40. The lock box control unit 40 is configured to provide a mechanism to electronically lock the smart container 10 so that an individual is unable to gain access to items stored within the smart container 10 without providing an access code. Referring to FIG. 6, an illustrative embodiment of the lock box control unit 40 is shown having a plurality of walls, two opposing side walls 42 and 44, a top wall 46, a bottom wall 48, a front wall 50, and a back wall 52, each arranged to enclose an interior region. The front wall 50 is preferably arranged so as to be accessible to a user, and fits adjacent to a cut out region or window 54 positioned within the front wall 20 of the smart container 10.

FIG. 7 provides a schematic representation of several components associated with the functionality of the lock box control unit 40. A control element, illustrated herein as an integrated circuit or chip 56, or any other central processing unit, is used to help drive or control one of more functions. The control unit 40 may also contain memory and the necessary software or hardware to derive and control functionality. The lock box control unit 40 contains a locking assembly which includes a locking receiving area 58 (See FIGS. 6 and 7), which includes a recessed area 60 sized and shaped to receive at least a portion of the zipper slider 32 and a pair of locking member housing units 62 and 64. The locking member housing units 62 and 64 are arranged in an opposing manner, in line with each other. Each locking member housing unit 62 and 64 has an interior region 66 and 68 sized and shaped to house and store a locking member, illustrated herein as a slidable pin 70.

As illustrated in FIG. 7, the slidable pin 70 can be slid to engage with a portion of the zipper slider 32, with a handle 72 of the zipper slider 32 positioned within the recessed area 60. The slidable pin 70 can be moved from the locking member housing unit 62 into an opening within the handle 72 and secured within the locking member housing unit 64. Such action, and reversal, allows for locking or unlocking of the front wall 20 of the smart container 10. The movement of the slidable pin may be controlled by an actuator 76, which may include motor and lever arm (not shown). Movement of the slidable pin 70 and/or actuator 76 may be controlled through the integrated circuit or chip 56, or any other central processing unit, via entering a first electronic code, i.e. a password (numbers, words, symbols, or combinations thereof) to lock the smart container 10. A second electronic code may be used to cause the slidable pin 70 and/or actuator 76 to move, resulting in the unlocking of the smart container 10. The lock box control unit may include a display unit, illustrated herein as a LED monitor 78. The LED monitor 78 may include a data input, such as a touch screen onto which a user can enter a password, such as numbers, letters, or combinations thereof. Alternatively, a keypad or keyboard may be used.

The lock box control unit 40 may be WIFI enabled to include wireless communication, with for example, a smart phone or tablet, and include the necessary hardware 80 and software 82 components to be WIFI enabled. While the use of WIFI is described, other wireless communications known to one of skill in the art may be used as well. A battery 84 with an external charge port, such as a USB port 86, may be used to drive functionality and provide recharging. A plurality of LED lights 88 may provide a user with various visual indications, such as green for indicating the unlocked position and red to indicate a locked position. The lock box control unit 40 may also include reset button 90. The lock box control unit 40 may also include a transmitter 87 or a receiver 89 for transmitting or receiving data or other electronic signals.

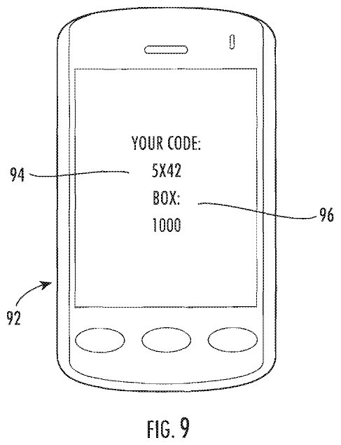

In use, the smart container 10 is configured to prevent a person from accessing the contents stored within. In the example of a food delivery, the smart container 10 would prevent delivery personnel from access to the food until it is delivered to the end user. Upon placing an order with a restaurant and completing the transaction, a user would be sent a unique electronic code that would be associated with a specific smart box 10. As illustrated in FIG. 9, an electronic device, shown as a smart phone 92, would receive and display an electronic password, or access code, 94, shown as “5X4Z”, which is associated with a particular smart container identification number 96, shown as “1000”. This number is used by the end user, the consumer that ordered the food, to unlock the smart container 10 when the food arrives at their location. The user checks to see if the smart container identification number 96 is correct, and then enters the electronic password 94 to allow the delivery agent access to the contents inside. The contents inside remain safe because the delivery agent does not have access to the code.

In addition, when the delivery agent arrives at the restaurant to pick up the food, it is the restaurant that places the food into the smart container 10 and locks the smart container 10. The restaurant may be required to put in an electronic code that locks the smart container 10 and is associated with that food delivery transaction, the smart container identification number 96, and the electronic password that was sent the end user. In this transaction, the delivery agent is unable to access the contents of the smart container 10 without the password 94 or without breaking the locking mechanism, which would then be detectable by the end user.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and ire defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A smart container for protecting contents stored within, comprising:
a plurality of walls arranged to enclose an interior portion, wherein at least one of said plurality of walls comprises a securing mechanism configured to allow said smart container to open or close; and
a lock box control unit configured to provide a mechanism to electronically lock said smart container so that access to items stored within is prevented without providing an access code.

2. The smart container for protecting contents stored within according to claim 1, wherein said smart container is made of a flexible or semi-flexible material, a hard material, or combinations thereof.

3. The smart container for protecting contents stored within according to claim 1, wherein said interior portion comprises a leak resistant lining configured to prevent liquids from damaging the smart container.

4. The smart container for protecting contents stored within according to claim 1, wherein said interior portion comprises a closed cell foam padding for providing insulation.

5. The smart container for protecting contents stored within according to claim 1, wherein said interior portion comprises a heat or cold reflective insulated interior with energy shield lining for keeping food hot, cold or frozen for a predetermined period of time.

6. The smart container for protecting contents stored within according to claim 1, wherein said securing mechanism includes a zipper slider that runs along two rows of protruding teeth.

7. The smart container for protecting contents stored within according to claim 1, wherein said lock box control unit comprises a control element configured to drive or control one or more functions.

8. The smart container for protecting contents stored within according to claim 7, wherein said control element is an integrated circuit or computer chip.

9. The smart container for protecting contents stored within according to claim 1, wherein said lock box control unit comprises a locking assembly.

10. The smart container for protecting contents stored within according to claim 1, wherein said lock box control unit includes a display unit.

11. The smart container for protecting contents stored within according to claim 1, wherein said display unit is an LED monitor.

12. The smart container for protecting contents stored within according to claim 11, wherein said LED monitor includes a touch screen onto which a user can enter a password.

13. The smart container for protecting contents stored within according to claim 1, wherein said lock box control unit includes a keypad.

14. The smart container for protecting contents within according to claim 1, wherein said lock box control unit may include wireless communication.

15. The smart container for protecting contents stored within according to claim 1, wherein said lock box control unit is configured to lock said smart container via first access code.

16. The smart container for protecting contents stored within according to claim 1, wherein said lock box control unit is configured to unlock said smart container via second access code.

17. The smart container for protecting contents within according to claim 1, further including a handle.
